(19) United States
(12) Patent Application Publication
(10) Pub. No.: US 2005/0274789 A1
(43) Pub. Date: Dec. 15, 2005

(54) Copying and billing system using a card

(75) Inventors: Edward P. Imes, Ontario, NY (US); James G. Stenzel, Rochester, NY (US)

Correspondence Address: Patent Documentation Center;Xerox Corporation, Xerox Square 20th Floor, 100 Clinton Ave. S., Rochester, NY, 14644, US

(73) Assignee: Xerox Corporation

(21) Appl. No.: 10/866,879

(22) Filed: Jun. 14, 2004

(51) Int. Cl. G06F 17/00; G06K 5/00

(52) U.S. Cl. 235/375; 235/380

(57) ABSTRACT

A method that includes delivering at least one document to a printing device, inserting a card containing a target email address into a card reader electronically connected to the printing device, and sending a copy of the document to the target email address. The method may also include offering a choice of printing locally or delivering the document to the target email address.

The embodiments disclosed herein are directed to methods for directing and billing for print jobs.

Currently, it is possible to conduct research at public and private institutions, and direct copies of online journals and articles to an email address. The same capability is not currently know to exist for hardcopy materials such as books and magazines.

Embodiments propose adding features to a smart card (for example, a debit card) that would enable a digital copy of a scanned image, in a standard graphic image format, to be automatically attached to an email note and sent to a predetermined email address. The mail address and billing of the service would be facilitated by the system currently in common use in public and collegiate libraries.

The embodiments disclosed herein propose sending an image resulting from scanning a book page, magazine page, or other document on a digital copier or other imaging device, in a standard graphics format, to a prescribed email address, wherein the information regarding the destination and billing details are contained on the card.

It is proposed that the currently commonplace billing systems in use in public and collegiate libraries as well as other places, that use a debit or “smart” card, be modified to accept an email address in addition to a monetary credit that is decremented as the card is used. It is further proposed that the address on the card be read into memory on the copying apparatus. It is further proposed that the copying apparatus be enhanced to include image transformation software. It is further proposed that the copying apparatus be enhanced with the ability to take a scanned image, transform the data into a standard graphics image format such as jpeg or gif, and then send out the image to a predetermined email address as an attachment on a standard SMTP mail note.

Embodiments include a method, which includes delivering at least one document to a printing device, inserting a card containing a target email address into a card reader electronically connected to the printing device, and sending a copy of the document to the target email address. Embodiments may also include offering a choice of printing locally or delivering the document to the target email address.

Various exemplary embodiments will be described in detail, with reference to the following figures, wherein:

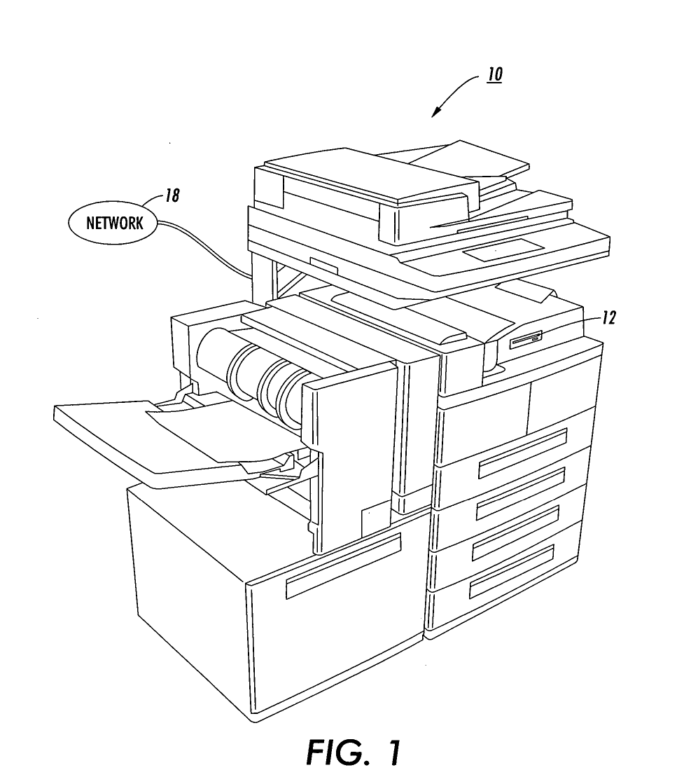

FIG. 1 schematically illustrates an exemplary embodiment of an image output device having a card reader and electronically connected to a computer network such as the Internet.

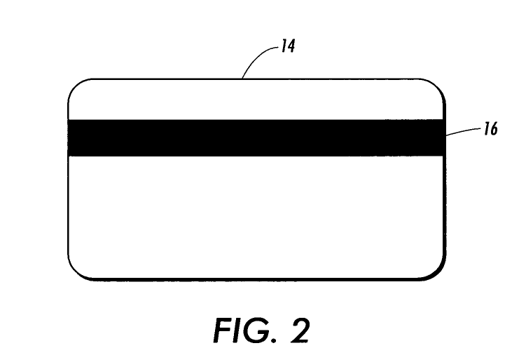

FIG. 2 schematically illustrates a card for use with the reader.

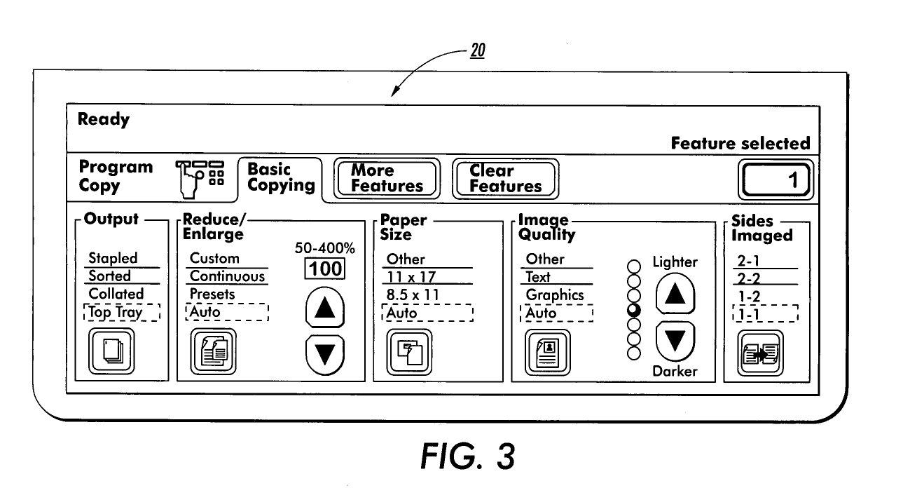

FIG. 3 schematically shows a top view of the image output device of FIG. 1, wherein an exemplary user interface is shown.

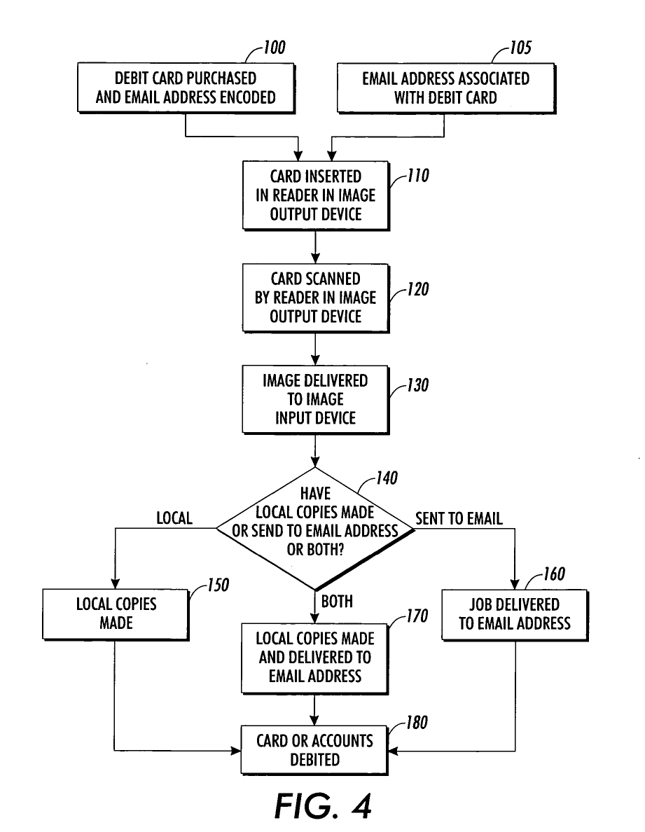

FIG. 4 illustrates a flowchart for a method of using the card and image output device of FIGS. 1 and 2.

Many image output devices, such as copiers and printers, are equipped with card readers today. For example, copiers with card readers may be found in libraries and copy shops. The card readers scan a user's card for credits the user has previously purchased or deposited into an account. The image output device then prints an image the user has supplied and rewrites the information on the card to reflect the reduction in credits.

FIG. 1 shows an exemplary embodiment of an image output device 10 equipped with a card reader 12. The image output device 10 will comprise image generation or retrieval equipment, typically a copier, but could also be another device or include other devices such as, for example, a scanner, fax, printer, or multifunction device. The user would carry a card 14 (as shown in FIG. 2) that would have information encoded on it that was readable by the device 10. This information will typically be encoded onto a magnetic strip 16 such as the one shown in FIG. 2. However, information could also be encoded in, for example, an optically readable format (such as, for example, a bar code or glyph) an infrared readable format, a UV readable format, or electronically encoded onto an electronic tag that would respond to an inquiry from the card reader.

In embodiments, the card 14 may be a smart card or it may be a traditional copy debit card that would typically include credits. The credits on the card would be decreased every time the user used the device. If the user were making copies, for example, the reader would scan the card to determine the amount of credit thereon. The reader would also be able to change the information on the card (for example, by rewriting the magnetic strip 16) each time a copy was made or after a series of copies were made with a fixed amount per copy deducted from the initial amount. The user previously would have applied credits to the card during purchase or after purchase through a number of known ways. For example, the user may insert the card into one slot on a device and money into another slot and the card would be ejected with the credits added to it.

In embodiments, the card 14 could also be a debit card having access information to a monetary account such as a bank account. The card reader would be connected to a computer network 18 such as the Internet (either directly or through the image output device), which would in turn be connected to the user's account. The device would then debit the user's account for a job. For example, the device could charge the user for each copy made, or alternatively, for a batch of copies made once the job was finished. In embodiments, it would initially query the user's account to determine how many copies could be made.

In embodiments, the card 14 could also be a credit card having a fixed limit. Similarly to the system described with respect to the debit card connected to a monetary account, the card reader would be connected to a computer network 18 such as the Internet (either directly or through the image output device), which would in turn be connected to the user's credit account. The device would then charge the user's account for a job, such as a copy job, up to the card's credit limit.

The information stored on the card 14 can also include other information. For example, the card may contain one or more email addresses. Rather than producing a sheet of paper or other media, the device 10 could send an image to the email address. The device 10 would be connected to the computer network 18. This network could be the Internet or it could be an internal network of devices. This output option saves paper and does not encumber the user.

In embodiments, the device 10 also includes a user interface 20 as shown in FIG. 3 that would prompt the user as to whether to produce a hardcopy locally or send it to one or more email addresses read from the card 14. The user could enter a choice through either a touch screen or an attached keyboard (not shown).

The card 14 may also contain an email address to which a receipt may be sent. In cases where the image output is sent to an email address, the address to which the receipt is sent may be the same address as where the image is sent. Alternatively the information stored on the card 14 may include one email address for image output and one for billing purposes.

If the card 14 has two or, more email addresses encoded onto it, the card may also contain encoded identifiers such that the device would know which email address to which to send a job output, or it could prompt the user for a selection among email addresses.

FIG. 4 is a flowchart of an exemplary method that may be performed by a user. In embodiments, a user would purchase a debit or smart card for the purpose of paying for copies to be made on the image output device 10 such as, for example, a vending (pay-per-copy) copier 100. At that time the user could optionally designate an email address to be coded onto the card in addition to the monetary credit purchased. Alternatively, the user would simply have an email address encoded onto his bank debit card 105. Subsequently, the user would be present his card 110 to the image output device 10 when an image output was desired. The email address coded on the card would then be read 120 by the card reader 12. The user would then deliver a print job to the device 130. If the user is making copies by scanning in an original, steps 110-130 will likely be performed in this order. If the user delivers the image to the device in some other manner (such as by download or by earlier electronic delivery) then step 130 may be performed before steps 110 and 120. When copying commences at the user's direction, the device 10 presents the user 140 with the option to have local copies delivered as usual 150, have an electronic image of the target copy sent to the designated email address 160, or both 170. The user would select the desired option and the debit card, or the account associated with the card, would be debited 180 for all transactions according to a predetermined billing schedule.

While the present invention has been described with reference to specific embodiments thereof, it will be understood that it is not intended to limit the invention to these embodiments. It is intended to encompass alternatives, modifications, and equivalents, including substantial equivalents, similar equivalents, and the like, as may be included within the spirit and scope of the invention. All patent applications, patents and other publications cited herein are incorporated by reference in their entirety.

1. A method, comprising:
delivering at least one document to a printing device;
inserting a card containing a target email address into a card reader electronically connected to the printing device;
sending a copy of the document to the target email address.

2. The method of claim 1, wherein the printing device includes a scanner and wherein delivering at least one document includes scanning a document with the scanner.

3. The method of claim 1, wherein delivering at least one document includes sending the print job from a remote location.

4. The method of claim 1, further comprising sending a receipt to the target email address.

5. The method of claim 1, wherein the card includes a magnetic strip that contains the target email address.

6. The method of claim 1, wherein the card includes credits that are used to purchase the copy of the document that is sent.

7. The method of claim 1, wherein the card contains access information to a monetary account, and wherein the copies are paid for with funds from the monetary account.

8. The method of claim 7, wherein the account is a bank account.

9. The method of claim 7, wherein the account is a credit account.

10. A method performed by an image output device, comprising:
receiving a document;
receiving a debit card containing a target email address;
offering a choice of printing locally or delivering the document to the target email address.

11. The method of claim 10, further comprising sending the document to the target email address when that choice is selected.

12. The method of claim 11, further comprising sending a receipt to the target email address.

13. The method of claim 10, wherein receiving a document includes receiving the document from a scanning device operably connected to the image output device.

14. The method of claim 10, wherein receiving a document includes receiving the document through a network from a remote location.

15. The method of claim 10, wherein the debit card includes a magnetic strip that contains the target email address.

16. The method of claim 10, wherein the card includes credits that are used to purchase the copy of the document that is sent.

17. A debit card containing a target email address so that when the card is read by a card reader connected to a printing device, the email address is read along with the credit information so that the device can send a print job to the email address.

18. The debit card of claim 17, wherein the card further comprises a magnetic strip that contains the target email address.

19. The debit card of claim 17, wherein the card further contains access information to a monetary account.
